(19) United States
(12) Patent Application Publication
(10) Pub. No.: US 2002/0095795 A1
(43) Pub. Date: Jul. 25, 2002

(54) Portable machine for cutting sheet material

(76) Inventor: Francisco Vidal Carres, Barcelona (ES)

Correspondence Address: MORGAN & FINNEGAN, L.L.P., 345 Park Avenue, New York, NY, 10154, US

(21) Appl. No.: 09/886,898

(22) Filed: Jun. 21, 2001

(30) Foreign Application Priority Data
Jan. 25, 2001 (ES) 200100178

(51) Int. Cl. B26B 15/00

(52) U.S. Cl. 30/228

(57) ABSTRACT

A portable machine for cutting sheet material, for cutting a strip of sheet material of a certain width comprising a frame having an elongate slot, two cutting rollers, and a stop arranged to be fixed in a position that defines the width, and comprising, additionally, a threaded shaft that defines an axis of rotation, and a support member with a threaded member, where the stop is fixedly attached to the support member, and where the shaft engages the threaded member, in such a way that a rotation of the shaft around the axis of rotation causes a displacement of the support member according to the axis of rotation.

### DESCRIPTION

1. Field of the Invention

The invention refers to a portable machine for cutting sheet material, for cutting a strip of sheet material of a certain width, of the type that comprises a frame with an elongate slot, two cutting rollers, and a stop arranged to be fixed in a position that defines the width of the strip that it is desired to cut.

2. Prior Art Reference

Portable machines of the aforementioned type are known. They are frequently used in carpentry work, in particular wood-working, do-it-yourself work, etc. These machines are particularly useful for cutting strips of plastics and stratified materials, such as Formica for example. The cut strips can be used for multiple applications, however, they are usually used for covering carpentry products, such as furniture, doors, etc., made from wooden boards, fiberboard, etc. These coverings must be cut, therefore, with great accuracy, since if they are cut too small, the material it is desired to cover is left partially uncovered, and if they are cut too large, an overhanging portion is left, which has to be removed later.

The existing machines on the market have a stop that can be slid manually along a guide way and that can be fixed in a certain position by means of a set-screw. However, the manual positioning is imprecise and usually requires several corrections before being able to locate the stop in the desired position. This problem is accentuated when the guide way is not in perfect condition (i.e. is dirty, loose, has suffered knocks, etc.) which means that the movement of the stop along the guide way is not smooth and even.

### SUMMARY OF THE INVENTION

It is an object of the invention to overcome these drawbacks. This object is achieved by means of a portable machine for cutting sheet material of the type first mentioned above which comprises, additionally, a mechanism for fine adjustment of the stop.

The fine adjustment mechanism may be of diverse types. Preferably it comprises a threaded shaft that defines an axis of rotation, and a support member having a threaded member, where the stop is fixedly attached to the support member, and where the shaft engages the threaded member, in such a way that a rotation of the shaft around the axis of rotation causes a displacement of the support member according to the axis of rotation. The threaded shaft is provided with a control knob at one end thereof, so that it can be rotated with ease, and in a smoother and more even way, although the machine is not in the best conditions (is dirty, has suffered knocks, etc.).

One particularly advantageous embodiment of the invention is obtained when the fine adjustment mechanism has a unlocking mechanism that allows the shaft to be disengaged from the threaded member, in such a way that the shaft and the support member can be moved independently one of the other. In this way an optimum combination of properties can be obtained. The shaft can have a fine thread, with a small thread pitch. It allows for a very precise positioning, since each thread turn is translated into a very small forward feed of the stop. It also means a much smoother fine positioning, since a smaller force is required in the fingers to overcome any possible resistance to the forward feed due, for example, to dirt. However, the unlocking mechanism allows a quick prepositioning to be effected, feeding forward over great distances quickly, without necessity of traversing the great distance by rotating the shaft which, as said above, has a small thread pitch.

A particularly interesting solution is obtained when the threaded member is an elongate body, with a threaded portion at one end, a pivot shaft at an intermediate point, and a pressure surface at the other end. In this way, a very simple and economic mechanism is obtained that fulfils all the foregoing requirements. The elongate body is attached to the support member by means of the pivot shaft. In the locked position the threaded portion is engaged with the shaft, and the fine adjustment can be carried out, since the rotation of the shaft forces the threaded portion to move (and, therefore, the whole elongate body and the support member fixedly attached thereto) in direction of the axis of rotation. When it is desired to disengage the shaft from the threaded member, the pressure surface thereof is pressed, whereby the threaded member pivots around the pivot shaft, and the threaded portion becomes disengaged from the shaft thread. At this time the threaded member can be moved (and, therefore, the whole elongate body and the support member fixedly attached thereto) freely independently of the shaft, and the stop can be prepositioned in approximately the desired position. The pressure surface is then released and a resilient means, for example a spring, urges the threaded member to pivot around again the pivot shaft until the threaded portion reengages the shaft thread. Once engaged, the fine adjustment can be carried out with the accuracy and convenience previously mentioned.

### BRIEF DESCRIPTION OF THE DRAWINGS

Further advantages and features of the invention will be appreciated from the following description, wherein, without any limiting nature, there is described a preferred embodiment of the invention, with reference to the accompanying drawings, in which:

FIG. 1 is a perspective view of a portable machine for cutting sheet material in accordance with the invention.

FIG. 2, a longitudinal section view, along the axis of turn of the shaft, of the machine of FIG. 1.

FIG. 3, a cross section view, through the region of the support member, of the machine of FIG. 1.

### DETAILED DESCRIPTION OF THE INVENTION

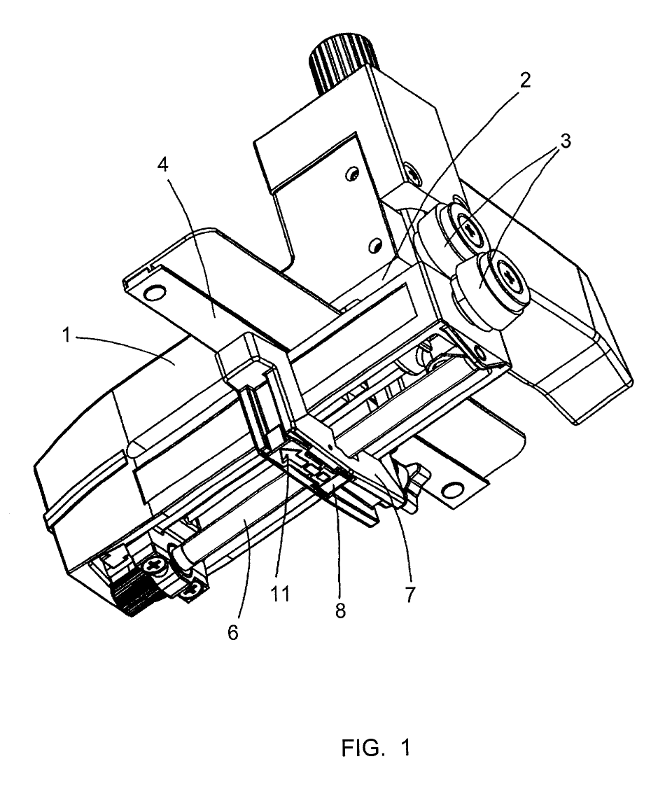

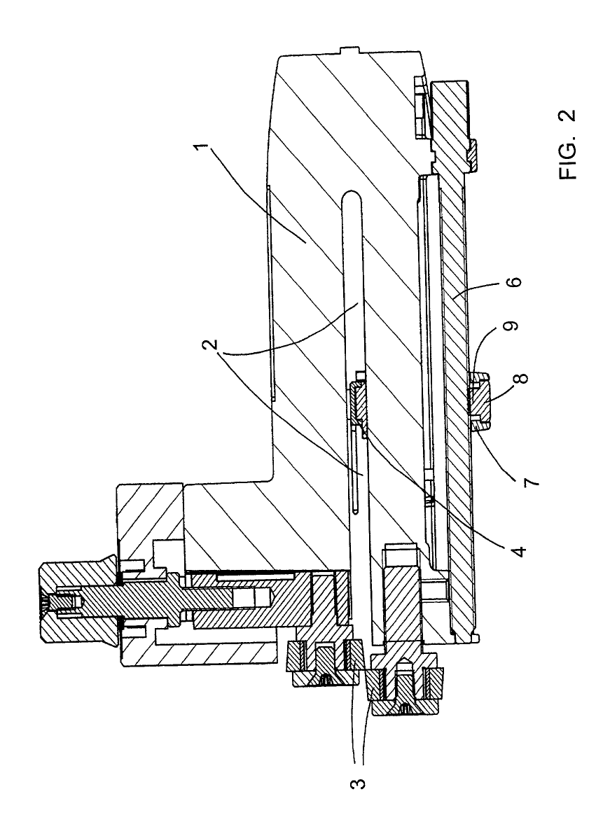

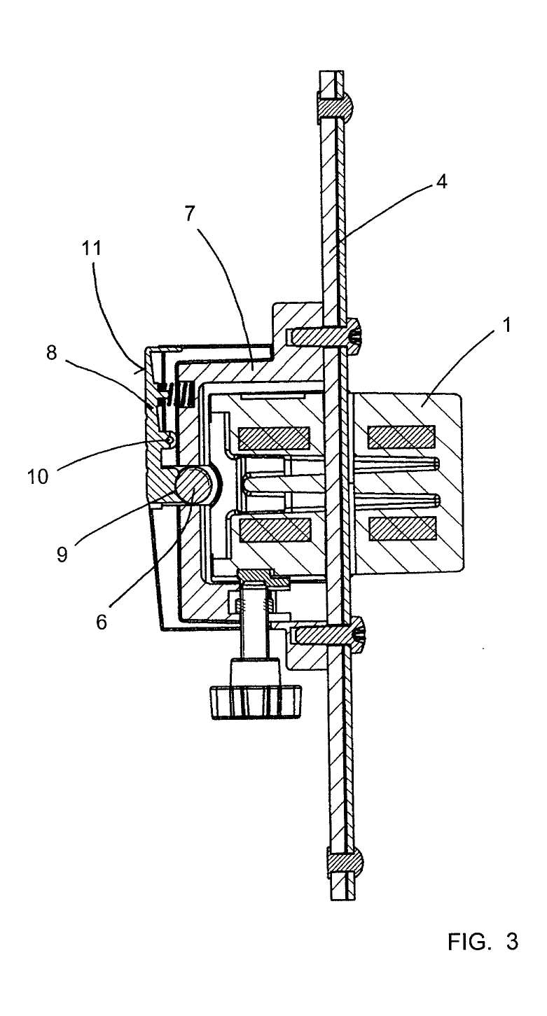

The portable machine shown in FIGS. 1 to 3 has a frame 1, which is substantially an elongate body having a slot 2 at an intermediate point. The slot 2 divides the frame 1 such that it form a high narrow arch, similar to a flattened “C”. At the end of each of the arms of the arch, there is a cutting roller 3, so that both cutting rollers 3 have their cutting surfaces facing each other. The distance between the cutting rollers 3 can be adjusted by means of an adjustment screw.

To cut a strip of sheet material, the sheet material is fed between the two arms of the arch, and the two cutting rollers 3 cut the strip of sheet material. To fix the width of the strip that it is desired to cut, the machine is provided with a stop 4.

The machine is provided with a fine adjustment mechanism to move the stop 4. The fine adjustment mechanism has an shaft 6 that has the central portion of the outer surface thereof threaded. At one end thereof, the shaft 6 has a control knob, arranged to be operated with the fingers. When knob is operated, the shaft 6 rotates about the axis thereof, defining an axis of rotation. The stop 4 is attached to a support member 7 in such a way that they surround one of the arms of the arch, and in such a way that they can slide therealong, so that the arch fulfils the function of guide way of the combined stop/support member. The support member 7 has a threaded member 8 that is attached to the support member 7 through a pivot shaft 10. The threaded member 8 has a threaded portion 9 which is the portion adapted to engage with the shaft thread 6, and a pressure surface 11 thereof which is the portion which pressed so that the threaded member 8 pivots around the pivot shaft 10 and the threaded portion 9 becomes disengaged from the shaft 6. A spring urges the threaded member 8 to return to the position of engagement.

The support member 7 is provided additionally with a set-screw that allows the stop 4 to be set in the definitive position before carrying out the cut. The support member 7 is also provided with a graduated scale on which the cutting width can be measured.

What I claim is:

1.- A portable machine for cutting sheet material, for cutting a strip of sheet material of a certain width, of the type that comprising a frame having an elongate slot, two cutting rollers, and a stop arranged to be fixed in a position that defines said width, additionally comprising a fine adjustment mechanism for said stop.

2.- The portable machine according to claim 1, wherein said fine adjustment mechanism comprises a threaded shaft that defines an axis of rotation, and a support member with a threaded member, where said stop is fixedly attached to said support member, and where said shaft engages said threaded member, in such a way that a rotation of said shaft around said axis of rotation causes a displacement of said support member according to said axis of rotation.

3.- The portable machine according to one of claim 1 or 2, wherein said fine adjustment mechanism has a unlocking mechanism that allows said shaft to be disengaged from said threaded member, in such a way that said shaft and said support member can be moved independently one of the other.

4.- The portable machine according to at least one of claims 1 to 3, wherein said threaded member is an elongate body, with a threaded portion at one end, a pivot shaft at an intermediate point thereof, and a pressure surface at the other end.
